(19) United States
(12) Patent Application Publication
(10) Pub. No.: US 2026/0239260 A1
(43) Pub. Date: Aug. 13, 2026

(54) SEAMLESS ROAMING WITHIN A SEAMLESS MOBILITY DOMAIN

(71) Applicant: Cisco Technology, Inc., San Jose, CA (US)

(72) Inventors: Binita GUPTA, San Diego, CA (US); Brian D. HART, Sunnyvale, CA (US); Stephen M. ORR, Wallkill, NY (US); Malcolm M. SMITH, Richardson, TX (US); Indermeet S. GANDHI, San Jose, CA (US)

(21) Appl. No.: 19/637,515

(22) Filed: Apr. 2, 2026

Related U.S. Application Data
(63) Continuation of application No. 18/986,246, filed on Dec. 18, 2024.
(60) Provisional application No. 63/612,282, filed on Dec. 19, 2023.

(51) Int. Cl. H04W 60/00; H04W 12/06; H04W 36/18; H04W 76/25

(52) U.S. Cl. CPC H04W 60/005; H04W 12/06; H04W 36/18; H04W 76/25

(57) ABSTRACT

Techniques and apparatus for facilitating seamless roaming within a seamless mobility domain (SMD) are described. An example technique performed by a wireless device includes performing an association to a SMD. The SMD includes multiple access point (AP) multi-link devices (MLDs), and each of the AP MLDs includes a respective one or more APs. The wireless device roams among the AP MLDs within the SMD while maintaining association to the SMD.

### CROSS-REFERENCE TO RELATED APPLICATIONS

This application is a continuation of co-pending U.S. patent application Ser. No. 18/986,246 filed Dec. 18, 2024, which claims benefit of United States provisional patent application Ser. No. 63/612,282 filed Dec. 19, 2023, which is now expired. The aforementioned related patent applications are herein incorporated by reference in their entirety.

### TECHNICAL FIELD

Embodiments presented in this disclosure generally relate to wireless communications. More specifically, embodiments disclosed herein relate to techniques for facilitating seamless roaming within a seamless mobility domain.

### BACKGROUND

Wireless communication standards, such as the Institute of Electrical and Electronics Engineers (IEEE) 802.11 technical standard, are continuing to evolve to meet the ever increasing demands of bandwidth intensive and low latency services, such as augmented/extended reality and cloud gaming. Recent amendments to IEEE 802.11 (e.g., IEEE 802.11be amendment and later amendments) aim to introduce higher data rates using higher modulation orders, larger channel widths, and additional spatial streams, as well as a set of new features such as multi-link operation (MLO), as an illustrative example.

MLO enables multi-link devices (MLDs), such as access points (AP) MLDs and station (STA) MLDs, to simultaneously send and receive data across different frequency bands and channels. With MLO, multiple links can be established between the STA MLD and the same or different AP MLD to increase throughput, reduce latency, and improve reliability. MLO thus enables a multi-link AP logical entity (e.g., AP MLD) and a multi-link non-AP logical entity (e.g., STA MLD) to use multiple paths for user plane traffic.

In addition to new features, such as MLO, the next generation of IEEE 802.11 (e.g., WiFi 8) defines a multi-link (ML) reconfiguration procedure for adding and deleting links without requiring reassociation. However, such procedures may pose challenges to enabling seamless roaming across AP MLDs within a wireless network.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example architecture of a multi-link device, according to certain embodiments.

FIG. 3 illustrates an example network architecture including one or more seamless mobility domains (SMDs), according to certain embodiments.

FIG. 4 illustrates an example network architecture for association to a SMD, according to certain embodiments.

FIGS. 5A-5B illustrate an example scenario for an add link operation during seamless roaming within a SMD, according to certain embodiments.

FIG. 6 illustrates an example call flow for an add link operation during seamless roaming within a SMD, according to certain embodiments.

FIG. 7 illustrates another example call flow for an add link operation during seamless roaming within a SMD, according to certain embodiments.

FIG. 8 illustrates an example workflow for generating a seamless mobility domain signature, according to certain embodiments.

FIG. 9 illustrates an example call flow for associating with a SMD, according to certain embodiments.

FIG. 10 illustrates an example frame format for a SMD element, according to certain embodiments.

FIG. 11 illustrates an example frame format for a SMD capabilities and operations field within the SMD element of FIG. 10, according to certain embodiments.

FIG. 12 is a flowchart of a method for facilitating seamless roaming within a SMD, according to certain embodiments.

FIG. 13 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### overview

One embodiment described herein is a computer-implemented method for wireless communications performed by a wireless device. The computer-implemented method includes performing an association to a seamless mobility domain (SMD). The SMD includes a plurality of access point (AP) multi-link devices (MLDs), each of the plurality of AP MLDs including a respective one or more APs. The computer-implemented method also includes roaming among the plurality of AP MLDs within the SMD while maintaining association to the SMD.

Another embodiment described herein is a computing device. The computing device includes one or more memories collectively storing instructions, and one or more processors communicatively coupled to the one or more memories. The one or more processors are individually or collectively configured to execute the instructions to cause the computing device to perform an operation. The operation includes performing an association to a seamless mobility domain (SMD). The SMD includes a plurality of access point (AP) multi-link devices (MLDs), each of the plurality of AP MLDs including a respective one or more access points (APs). The operation also includes roaming among the plurality of AP MLDs within the SMD while maintaining association to the SMD.

Another embodiment described herein is a non-transitory computer-readable medium. The non-transitory computer-readable medium includes computer-executable code, which when executed by one or more processors of a computing device perform an operation. The operation includes performing an association to a seamless mobility domain (SMD). The SMD includes a plurality of access point (AP) multi-link devices (MLDs), each of the plurality of AP MLDs including a respective one or more access points (APs). The operation also includes roaming among the plurality of AP MLDs within the SMD while maintaining association to the SMD.

### EXAMPLE EMBODIMENTS

Certain embodiments described herein provide techniques, systems, and apparatus for facilitating seamless roaming among multiple AP MLDs within a seamless mobility domain (SMD).

Seamless roaming capability has been area of focus for improving roaming quality within wireless networks, such as campus/extended service set (ESS) networks. To support seamless roaming/mobility in a campus wide wireless network, STAs can create association with the campus/ESS instead of with an individual AP or AP MLD (having multiple APs). In some examples, the ESS may be represented by a SMD. In other examples, in the case that the campus/ESS network is a global network, then there may be multiple mobility domains (MDs) (e.g., fast basic service set (BSS) transition (FT) MDs defined in IEEE 802.11r) associated with the campus/ESS network, where each MD includes a respective one or more SMDs. As used herein, a “mobility domain” may refer to a set of basic service sets (BSSs), within the same ESS, that support fast BSS transitions between themselves and that are identified by the set's mobility domain identifier (MDID). As used herein, a SMD refers to a logical entity to which a STA MLD associates, defines a set of AP MLDs within the same ESS that coordinate with each other to support seamless roaming between themselves, and that is identified by an SMD medium access control (MAC) address. In some cases, an SMD may also be referred to herein as a SMD MLD (MDM).

As described in certain embodiments herein, the STA can create its association with the ESS network represented by one or more SMDs instead of associating with a single AP or single AP MLD (having one or more APs) within the ESS network. In this manner, the techniques, systems, and apparatus for associating with an SMD(s) enable the STA to roam seamlessly between AP MLDs without requiring (re)association and (re)establishment of contexts with each new AP MLD. Advantageously, by enabling the STA to associate with an SMD(s) that covers multiple AP MLDs of the ESS network, the techniques, systems, and apparatus for associating with an SMD(s) described herein can significantly reduce roaming time to realize seamless roaming (e.g., smooth and continuous roaming with no apparent interruption in data communication) and significantly improve a STA's wireless performance in terms of increased throughput, reduced latency, and higher range, as illustrative, non-limiting examples.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”. As used herein, the terms “carrier,” “subcarrier,” “frequency channel,” “channel unit,” “channel,” and “tone” may be used interchangeably to refer to a frequency unit (or unit of frequency).

Note, the techniques described herein for facilitating seamless roaming among multiple AP MLDs within an SMD may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP, a controller, or a STA.

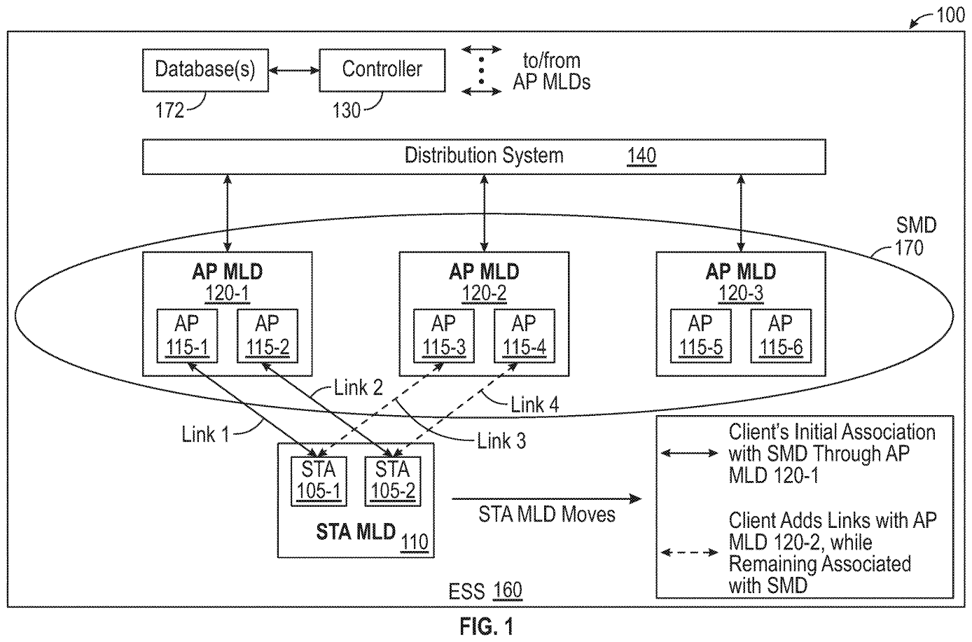

FIG. 1 illustrates an example system 100 in which one or more techniques described herein can be implemented, according to certain embodiments. As shown, the system 100 includes, without limitation, an ESS 160 (e.g., a campus/ESS network), which includes one or more basic service sets (BSSs) (not shown). ESS 160 includes an SMD 170, one or more AP MLDs 120 (e.g., AP MLD 120-1, AP MLD 120-2, and AP MLD 120-3) within the SMD 170, a STA MLD 110, a distribution system (DS) 140, a controller 130, and one or more databases 172.

Note although FIG. 1 depicts ESS 160 including a single SMD 170, in certain embodiments, the ESS 160 can be configured with multiple SMDs, each with one or more AP MLDs. By way of example, the ESS 160 can be used to cover multiple buildings of a campus (or large geographical area), where each building (or smaller geographical area within the larger geographical area) is covered by a respective SMD.

An AP MLD is generally a fixed station that communicates with STA MLD(s) and may be referred to as a base station, network entity, wireless device, or some other terminology. A STA MLD may be fixed or mobile and also may be referred to as a mobile STA MLD, a client MLD, a client STA MLD, a non-AP MLD, a wireless device, or some other terminology. Note that while a certain number of AP MLDs and STA MLDs are depicted, the system 100 may include any number of AP MLDs and STA MLDs.

As used herein, an AP MLD along with the STA MLDs associated with the AP MLD (e.g., within the coverage area (or cell) of the AP MLD) may be referred to as a BSS. The AP MLD 120-1, AP 120-2, and AP 120-3 may be neighboring (peer) AP MLDs. The AP MLDs 120 may communicate with one or more STA MLDs 110 on the downlink and uplink. The downlink (e.g., forward link(s)) is the communication link(s) from the AP 120 MLD to the STA MLD(s) 110, and the uplink (e.g., reverse link(s)) is the communication link(s) from the STA MLD(s) 110 to the AP 120. In some cases, a STA MLD may also communicate peer-to-peer with another STA MLD.

The AP MLDs 120 and the STA MLD 110 are generally representative of any device capable of performing multi-link operations. Each AP MLD 120 includes two APs (which may be referred to herein as “radios”). As illustrated, AP MLD 120-1 includes AP 115-1 and AP 115-2, AP MLD 120-2 includes AP 115-3 and AP 115-4, and AP MLD 120-3 includes AP 115-5 and AP 115-6. Similarly, STA MLD 110 includes two STAs 105-1 and 150-2 (which may be referred to herein as “radios”).

As used herein, the term “radio” may refer to the capability to connect to a peer device on a link. Thus, by way of example, the two APs 115-1 and 115-2, as depicted within AP MLD 120-1, may represent either two physical radios or two logical radios enabled by a single physical radio (which is capable of being used on two different links in a time-switched fashion). Similarly, the two STAs 105-1 and 150-2, as depicted within STA MLD 110, may represent either two physical radios or two logical radios enabled by a single physical radio (which is capable of being used on two different links in a time-switched fashion).

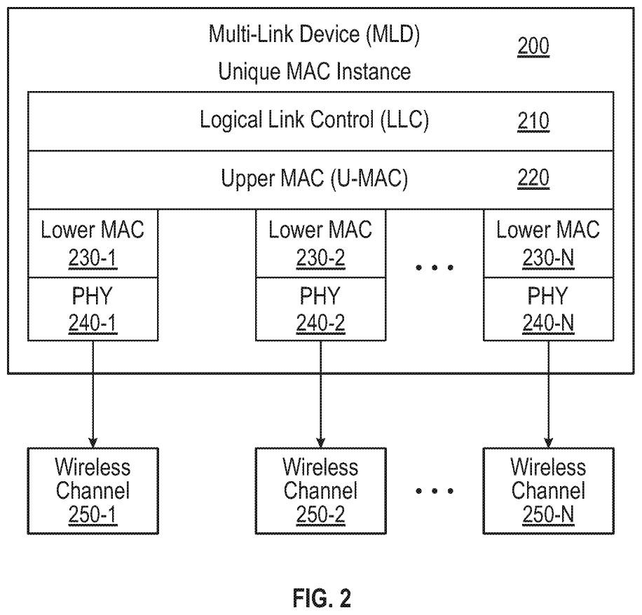

FIG. 2 illustrates an example architecture of a MLD 200, according to certain embodiments. The MLD 200 may be an AP MLD 120 or a STA MLD 110. As depicted in FIG. 2, the MLD 200 provides a unique MAC instance to multiple wireless interfaces (e.g., wireless channels 250 1-N), each of which may be utilized by a respective “radio” (e.g., AP 115 or STA 105). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding physical (PHY) layer 240 as well as link specific functionalities (e.g., channel access) for the corresponding wireless channel 250.

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

Referring back to FIG. 1, in certain embodiments, the AP MLDs 120 may be controlled or managed at least partially by the controller 130. Here, the controller 130 couples to and provides coordination and control for the AP MLDs 120 1-3. For example, the controller 130 may handle adjustments to RF power, channels, authentication, and security for the AP MLDs 120. The controller 130 may also coordinate the links formed by the AP MLDs 120. Each AP MLD 120 may maintain a respective connection to the DS 140, which may be configured to manage client roaming across multiple AP MLDs within the SMD 170 and/or ESS 160. In certain embodiments, the DS 140 may include or otherwise be implemented by the controller 130.

The operations of the controller 130 may be implemented by any device or system, and may be combined or distributed across any number of systems. For example, the controller 130 may be a WLAN controller for the deployment of AP MLDs 120 within the system 100. In some examples, the controller 130 is included within or integrated with an AP MLD 120 and coordinates the links formed by that AP 120 (or otherwise provides control for that AP MLD). For example, each AP MLD 120 may include a controller that provides control for that AP MLD. In some embodiments, the controller 130 is separate from the AP MLDs 120 and provides control for those AP MLDs. In FIG. 1, for example, the controller 130 may communicate with the AP MLDs 120 1-3 via a (wired or wireless) backhaul. The AP MLDs 120 1-3 may also communicate with one another, e.g., directly or indirectly via a wireless or wireline backhaul. The database(s) 172 are representative of storage systems that may include, without limitation, radio resource configurations and radio resource management (RRM) information, among other information.

In certain embodiments, the system 100 is representative of a seamless roaming architecture. Within system 100, seamless roaming is enabled within the SMD 170. The SMD 170 includes multiple AP MLDs 120 across which seamless roaming is supported, extending the FT MD defined in IEEE 802.11r. As noted, in certain embodiments, an SMD 170 covers all AP MLDs of an ESS (e.g., ESS 160). In other embodiments, the ESS 160 may include multiple SMDs.

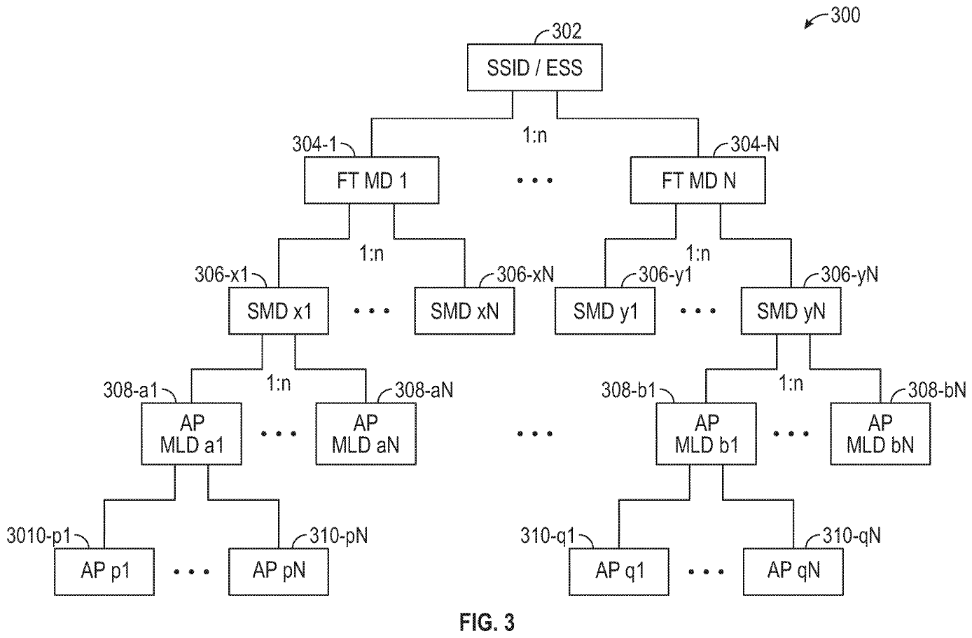

By way of example, FIG. 3 illustrates an example network architecture 300 including one or more SMDs, according to certain embodiments. Here, the network architecture 300 includes an ESS 302, which may be associated with or otherwise represented by a service set identifier (SSID). The ESS 302 may be an illustrative example of the ESS 160 illustrated in FIG. 1.

As shown, the ESS 302 includes one or more FT MDs 304 1-N (e.g., an FT MD defined in IEEE 802.11r). Each FT MD 304 may be identified by an FT MD identifier (FT MD ID) and may include a respective one or more SMDs 306. For example, FT MD 304-1 includes SMDs 306 x1-xN and FT MD 304-N includes SMDs 306 y1-yN. Each SMD 306 may be an illustrative example of the SMD 170 illustrated in FIG. 1. Each SMD 306 may include a respective one or more (non-collocated) AP MLDs 308. In FIG. 3, for example, SMD 306-x1 includes AP MLDs 308 a1-aN and SMD 306-yN includes AP MLDs 308 b1-bN. Each AP MLD 308 may be an illustrative example of the AP MLD 120 illustrated in FIG. 1. Each AP MLD 308 may include one or more (collocated) APs 310. For example, AP MLD 308-a1 includes APs 310 p1-pN and AP MLD 308-b1 includes AP 310 q1-qN. Each AP 310 may be an illustrative example of the AP 115 illustrated in FIG. 1.

Referring back to FIG. 1, in certain embodiments, each SMD (e.g., SMD 170) is uniquely identified in the ESS 160 with a virtual MAC address, referred to herein as an SMD MAC address (or SMD MLD identifier (MDMI)). Each AP MLD 120 may be configured with the identifier of the SMD (e.g., SMD MAC address) that the AP MLD 120 belongs to. In FIG. 1, for example, AP MLDs 120 1-3 may each be configured with the SMD MAC address associated with SMD 170. The respective APs 115 associated with each AP MLD 120 may advertise SMD information (for that AP MLD 120) in beacon frames transmitted by the APs 115.

Note, in certain embodiments, a network identifier (NID) may be considered to correspond to a MDMI (with global scope and similar characteristics) if the SMD is not present. In such embodiments, at the time of association, the NID can be assigned to a configured SMD by updating the NID's advertised package for the purpose of roaming within the SMD.

In certain embodiments, the SMD 170 defines a single security domain where all AP MLDs 120 within the SMD 170 are trusted (and in the same ESS 160). In such embodiments, a client STA 110 can establish a single secure association with this trusted security domain, and all AP MLDs 120 of the SMD 170 can be configured to have the same set of cryptographic encryption key (e.g., same set of cipher suites). To achieve seamless roaming, the STA MLD 110 (or non-AP MLD) can initially associate with the SMD 170 through one of the AP MLDs 120 (e.g., within the SMD 170. As shown in FIG. 1, the STA MLD 110 may associate with the SMD 170 through AP MLD 120-1. Here, the STA MLD 110 initially connects to AP 120-1 through two links: link 1 and link 2. Link 1 connects STA 105-1 to AP 115-1, and link 2 connects STA 105-2 to AP 115-2.

For seamless roaming, the STA MLD 110 maintains its association and security context associated with the SMD 170 as it roams within the SMD 170, e.g., to avoid reauthentication, reassociation, and rekeying delays. As the STA MLD 110 moves away from AP MLD 120-1, the STA MLD 110 may roam to one or more other AP MLDs 120 2-3. For example, as the STA MLD 110 moves towards AP MLD 120-2, the STA MLD 110 may intend to establish (or add) two new links: link 3 between STA 105-1 and AP 115-3 and link 4 between STA 105-2 and AP 115-4. The STA MLD 110 may add links 3 and 4 while remaining associated with the SMD 170, thus facilitating seamless roaming of the STA MLD 110 among the AP MLDs 120 within the SMD 170.

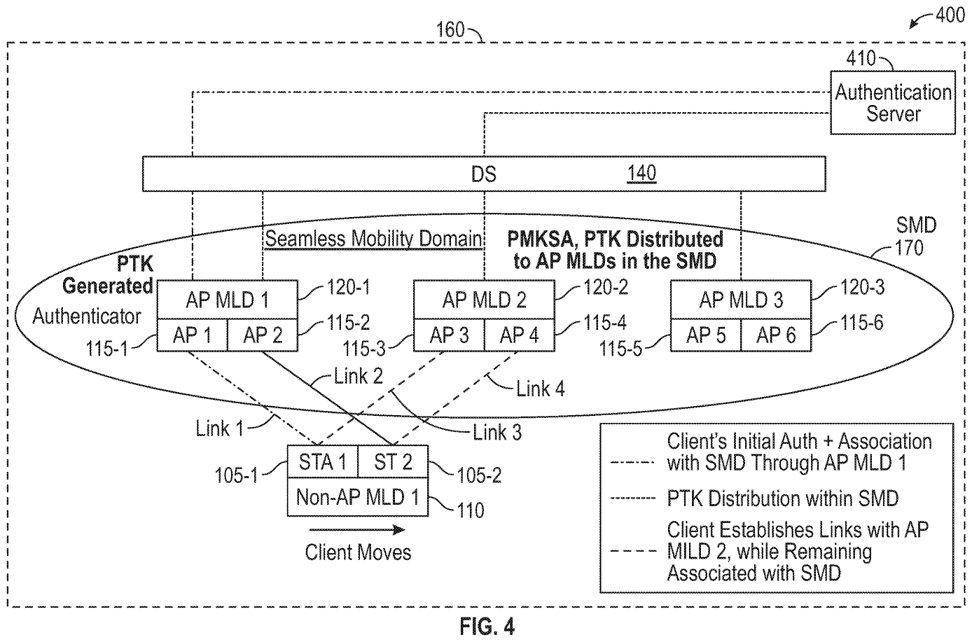

Certain embodiments described herein may enhance association procedures in order to support association to an SMD, such as SMD 170. FIG. 4 depicts an example network architecture 400 for association to a SMD 170, according to certain embodiments. Here, the network architecture 400 includes an authentication server 410 (e.g., IEEE 802.1x authentication server), which is configured to generate a security context to be used by one or more AP MLDs 120 to facilitate seamless roaming by the STA MLD 110 within the SMD 170.

With reference to FIG. 4, in certain embodiments, a single unicast key/pairwise transient key (PTK) is generated for initial association to the SMD 170. In certain examples, the STA MLD 110 and the AP MLD 120-1 may participate in an authentication procedure (e.g., four-way handshake procedure defined in 802.1X) to establish the PTK, based at least in part on a pairwise master key (PMK) known to each of the STA MLD 110 and AP 120-1. The SMD MAC address associated with the SMD 170 may be used in the generation of the PTK to tie (or associate) the PTK to the SMD 170.

The initial association to the SMD 170 establishes a security context that applies to all AP MLDs 120 within the SMD 170. In some examples, the AP MLD 120-1 may provide an indication of the PMK/PTK to the DS 140, which uses the PMK/PTK to generate the security context. The security context may include a pairwise master key security association (PMKSA), a pairwise transient key security association (PTKSA), PMK, authenticator MAC address, PMK lifetime, pairwise master key identifier (PMKID), or any combination thereof, among other information.

After the STA MLD 110's initial association with the SMD 170 through AP MLD 120-1, the authentication server 410 may distribute the security context to each of the AP MLDs 120 1-3 using the backend infrastructure (e.g., DS 140, controller 130, or a combination thereof). Additionally, the backend infrastructure may provide group transient keys (GTKs) for added links to a target AP MLD (e.g., AP MLD 120-2) to the STA MLD 110 as part of an add link operation to that target AP MLD. In FIG. 4, when the STA MLD 110 roams to another target AP MLD (e.g., AP MLD 120-2), the STA MLD 110 may send a roaming add link request (e.g., link reconfiguration request frame) to the target AP MLD to indicate that the STA MLD 110 is moving links within the SMD 170. Here, because all of the AP MLDs 120 within the SMD 170 share the same security context, the STA MLD 110 and/or target AP MLD 120 can avoid the delay associated with PTK regeneration and medium access control protocol data unit (MPDU) decryption/encryption (in case of data transfer across AP MLDs) during roaming.

### Seamless Roaming Using Add Link Operation Within a SMD

In certain wireless networks (e.g., IEEE 802.11be), a STA MLD may add links to its ML setup without the need for reassociation by sending a link reconfiguration request frame to the AP. The link reconfiguration request frame may include a reconfiguration ML element, which further includes a per-STA profile subelement that contains parameters relevant to the operation and establishment of the new link for the non-AP MLD. When receiving the link reconfiguration request frame, the AP evaluates these parameters and determines whether the new link can be added based on network policies and available resources. If the AP approves the request and decides to establish the link, then the AP sends a link reconfiguration response frame to the STA MLD. The link reconfiguration response frame may include configuration information within the basic ML element, such as the new link's parameter, channel access settings, and security credentials for setting up the link.

Certain embodiments described herein may enhance the multi-link (ML) reconfiguration procedure for adding and deleting links without requiring association (e.g., the IEEE 802.11be Add/Delete link procedure) in order to enable seamless roaming across AP MLDs 120 within a SMD, such as SMD 170. That is, embodiments herein define enhancements to the ML reconfiguration procedure to enable seamless addition and deletion of links within a SMD, such as SMD 170. In certain embodiments, when adding or deleting a link with an AP MLD, the STA MLD 110 may modify the link reconfiguration request to include a SMD MLD information element (IE), which indicates that the add and/or delete link is with the SMD 170. The SMD MLD IE may include an indication of the SMD MAC address (or MDMI) with which the STA MLD 110 is associated with.

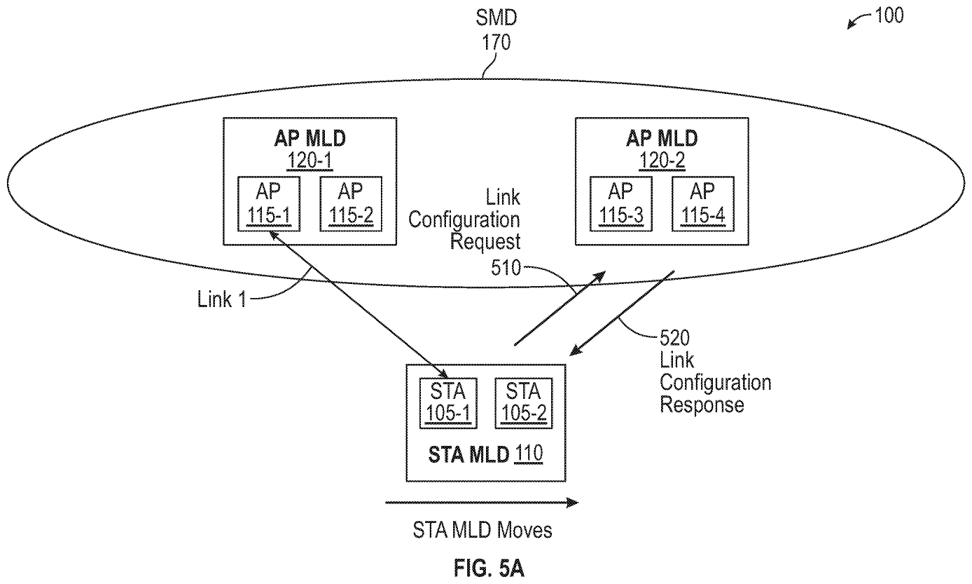

FIGS. 5A-5B illustrate an example scenario for an add link operation during seamless roaming within a SMD, according to certain embodiments. As shown in FIG. 5A, the STA MLD 110 may initially associate with the SMD 170 through AP MLD 120-1. Here, the STA MLD 110 initially connects to AP 120-1 through link 1, which connects STA 105-1 to AP 115-1.

When the STA MLD 110 roams to AP MLD 120-2, the STA MLD 110 may attempt to establish a new link between STA 105-1 (or STA 105-2) and AP 115-3 (or AP 115-4) of AP MLD 120-2 by sending a link reconfiguration request frame 510 to the AP 115-3. As shown in FIG. 5A, in certain embodiments, when the STA MLD 110 is adding a link which belongs to a different target AP MLD 120-2 than the current (or source) AP MLD 110-1 that the STA MLD 110 has established the ML setup with, the STA MLD 110 may send the link reconfiguration request frame 510 with the SMD MLD IE included to the target AP MLD 120-2.

In certain examples, the target AP MLD 120-2 may be already configured with the PTK (as well as other information associated with the security context) for the STA MLD 110. In such examples, the source AP MLD 120-1 to which the STA MLD 110 initially associated may push the PTK to other AP MLDs 120-2 of the SMD 170 (e.g., via the backend infrastructure).

In other examples, the target AP MLD 120-2 may retrieve the PTK (as well as other information associated with the security context) for the STA MLD 110 from a storage system (e.g., database(s) 172, controller 130, authentication server 410, etc.). By way of example, the target AP MLD 120-2 may retrieve the PTK from a distributed or centralized key store (e.g., at the controller 130, authentication server 410, and/or databases 172).

In FIG. 5A, the target AP MLD 120-2 may process the encrypted link reconfiguration request frame 510 using the same PTK that is shared across all AP MLDs 120 within the SMD 170. The target AP MLD 120-2 generates a new association ID (AID) value (within the scope of that AP MLD 120-2) for the STA MLD 110 and sends that AID in the link reconfiguration response frame 520. The new AID value within the link reconfiguration response frame 520 allows the STA MLD 110 to be identified within the target AP MLD 120-2. For example, the STA MLD 110 may have multiple AID values assigned to it, one per AP MLD with which it has established ML setup. Allowing the STA MLD 110 to have multiple AID values enables the AID space to be within the AP MLD's scope, instead of making the AID space global across all AP MLDs of a SMD. Enabling the AID space to be within the AP MLD's scope may be technically advantageous since it can significantly reduce the size of beacons transmitted by AP MLDs by reducing the size of the traffic indication map (TIM) element and multi-link traffic element included within beacons.

Globally, the AIDs assigned to a STA MLD 110 can be identified with the (AP MLD MAC address, AID) tuple. Once the STA MLD 110 receives the link reconfiguration response frame 520 (including the AID) with success status for the add link, the STA MLD 110 has successfully added the link to its ML setup. Assuming the STA MLD 110 has links setup with multiple AP MLDs within the SMD 170, the STA MLD 110 may maintain a list of multiple AIDs assigned to the STA MLD 110.

As shown in FIG. 5B, in certain embodiments, once the STA MLD 110 has added one or more links (e.g., link 2) with a target AP MLD (e.g., AP MLD 120-2), the STA MLD 110 may send a link reconfiguration request frame 530 to delete link(s) (e.g., link 1) the STA MLD 110 has with the (old) AP MLD 120-1 in order to roam all its link(s) to the target AP MLD 120-2. The STA MLD 110 may receive a link reconfiguration response frame 540 indicating a success status for the deleted link (e.g., link 1). In this manner, seamless roaming by a STA MLD among AP MLDs of a SMD can be achieved.

In certain embodiments, the STA MLD 110 may indicate the delete link operation for the link (e.g. link 1) with the source AP MLD 120-1 along with the add link operation for the new link (e.g. link 2) when sending the link reconfiguration request frame 510 to the target AP MLD 120-2. In such embodiments, the link reconfiguration request frame 510 may include two reconfiguration ML elements, one for AP MLD 120-1 and another one for AP MLD 120-2. AP MLD 120-2 may then communicate the delete link operation to AP MLD 120-1. Note, the AP MLDs 120 within the SMD 170 may support AP-to-AP communication to signal delete link operations received via a STA MLD 110.

In certain embodiments, as part of the transitioning links to the target AP MLD 120-2, the source AP MLD 120-1 may transfer contexts including the packet number (PN), sequence number (SN), block acknowledge (BA) agreements, target wake time (TWT) agreements, stream classification service (SCS) setup, among other parameters/information associated with the transitioned link(s) to the target AP MLD 120-2 using the AP-to-AP exchange. The STA MLD 110 may then start to use the link(s) with the target AP MLD 120-2.

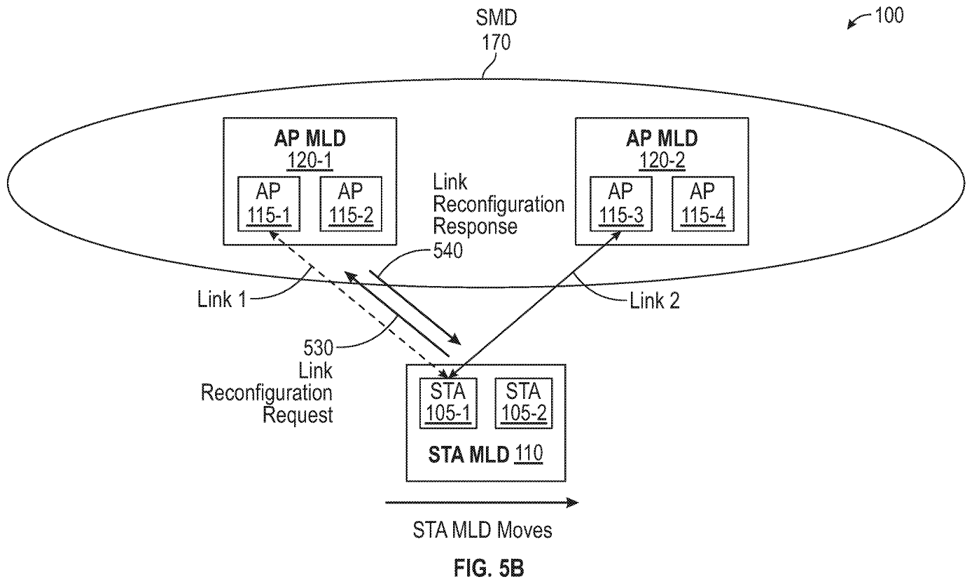

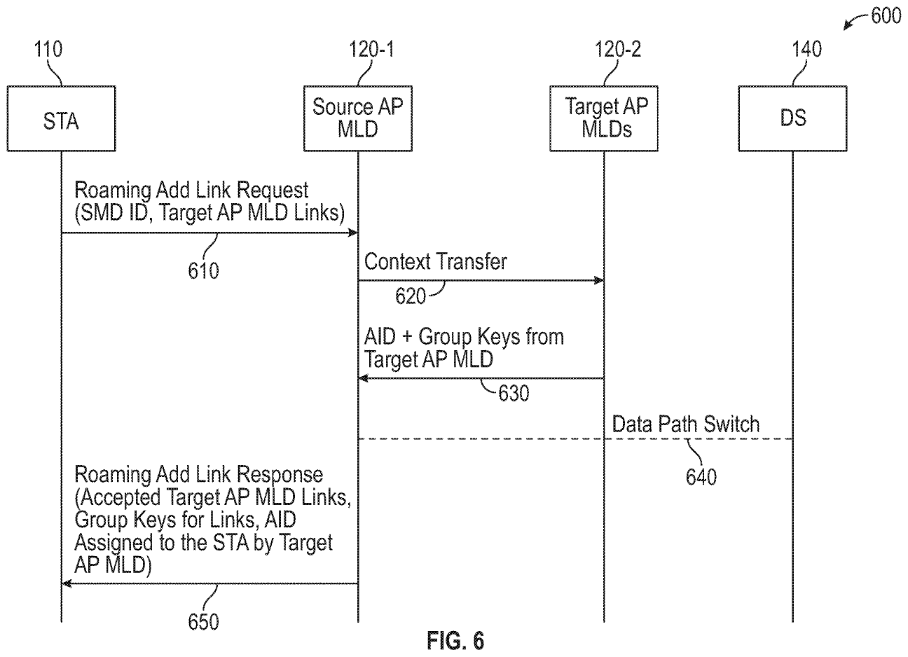

In certain embodiments, the add link operation described herein for roaming to a target AP MLD (e.g., AP MLD 120-2) can be performed via the source AP MLD (e.g., AP MLD 120-1) or directly with the target AP MLD. FIG. 6 is an example call flow 600 for an add link operation via a source AP MLD during seamless roaming and FIG. 7 is an example call flow 700 for an add link operation via a target AP MLD during seamless roaming, according to certain embodiments.

In FIG. 6, to achieve seamless roaming while adding links, the STA MLD (e.g., STA MLD 110) can perform an add link operation to add links with a target AP MLD (e.g., AP MLD 120-2) within the STA MLD's currently associated SMD (e.g., SMD 170) via the STA MLD's currently connected source AP MLD (e.g., AP MLD 120-1).

As shown in FIG. 6, at 610, the STA MLD transmits a roaming add link request to the source AP MLD. The roaming add link request may include an indication of the SMD ID (e.g., SMD MAC address, MDMI, etc.), target AP MLD link(s), among other information. At 620, in response to the roaming add link request, the source AP MLD transfers a security context for the STA MLD to the target AP MLD.

At 630, the target AP MLD assigns an AID to the STA MLD and provides an indication of the assigned AID and group keys for the added links to the source AP MLD. After a data path switch at 640, at 650, the source AP MLD transmits a roaming add link response to the STA MLD. The roaming add link response may include an indication of the accepted link(s) for the target AP MLD, group keys for the accepted links, and AID assigned to the STA MLD by the target AP MLD.

In FIG. 7, to achieve seamless roaming while adding links, the STA MLD (e.g., STA MLD 110) can perform an add link operation directly with a target AP MLD (e.g., AP MLD 120-2) within the STA MLD's currently associated SMD (e.g., SMD 170).

As shown in FIG. 7, at 710, the STA MLD transmits a roaming add link request directly to the target AP MLD. The roaming add link request may include an indication of the SMD ID (e.g., SMD MAC address, MDMI, etc.), target AP MLD link(s), among other information. At 720, in response to the roaming add link request, the target AP MLD transmits, to the source AP MLD (e.g., AP MLD 120-1), a request for the security context for the STA MLD. At 730, in response to the request, the source AP MLD transfers the security context for the STA MLD to the target AP MLD.

After a data path switch at 740, at 750, the target AP MLD transmits a roaming add link response to the STA MLD. The roaming add link response may include an indication of the accepted link(s) for the target AP MLD, group keys for the accepted links, and AID assigned to the STA MLD by the target AP MLD.

Advantageously, the techniques described herein for enhancing the ML reconfiguration add/delete link procedure may allow for seamless addition and deletion of links within a SMD, without reassociation.

### Cryptographic Identification of a Seamless Mobility Domain Multi-Link Device for Seamless Roaming

As noted herein, to provide smooth roaming/mobility in a campus wide wireless network, clients can create a “secure association” with an ESS instead of with an individual AP MLD. The ESS, for example, may be a global network with one or more campuses or a campus-wide network. As noted with respect to FIG. 2, in embodiments where the ESS is a global network with one or more campuses, each campus may correspond to (or be associated with) a respective SMD. On the other hand, in embodiments where the ESS maps to a single campus, the ESS may include a single SMD associated with campus.

In many wireless networks, “association” by a client generally refers to both the AP (MLD) through which the client transfers data (e.g., data plane) and the unicast keys used with that AP (MLD) for data transfer. As used herein, the term “secure association” generally refers to the later aspect of “association,” namely the transfer of the unicast keys used with an AP (MLD) for data transfer.

In certain embodiments described herein, the client (e.g., STA MLD) creates its secure association with the ESS network (e.g., ESS 160) represented by a SMD (e.g., SMD 170), instead of associating with a single AP (MLD) (e.g., AP MLD 120) within the ESS network. As noted, associating with the SMD instead of a single AP MLD may enable the client to roam seamlessly among the AP MLDs within the SMD without requiring (re)association and reestablishment of contexts with each new AP MLD, significantly reducing roaming time and improving the client's wireless performance.

In certain embodiments, affiliated APs (e.g., APs 115) of an AP MLD (e.g., AP MLD 120) that is part of an SMD (e.g., SMD 170) can advertise the SMD identifier (e.g., SMD MAC address or MDMI) in the beacon and probe response frames, so that STA MLDs (e.g., STA MLD 110) can identify which APs are part of the SMD (or MDM). However, in some cases, there may be rogue APs within the network that masquerade as legitimate APs of the SMD. Accordingly, one of the challenges with advertising the SMD identifier relates to how a client can establish trust for the SMD identifiers that are being advertised (and hence the transmitter's membership within an SMD) from nearby AP(s).

For instance, without establishing cryptographic trust for the advertised SMD identifier, a client may connect to a rogue AP acting as a man-in-the-middle (MITM) for a legitimate AP connected to the campus network. Since techniques described herein allow the client to establish association once with the SMD, as opposed to requiring the client to establish association separately with each AP MLD, from a security perspective, it is crucial that the client ensure that is connecting to a legitimate AP (MLD) of the SMD at the time of data transfer with the SMD.

To address this, certain embodiments described herein provide techniques for cryptographic Identification of a SMD MLD for seamless roaming. As described herein, certain embodiments define a mechanism such that a client can cryptographically establish trust for (i) the SMD and (ii) verify whether an AP (MLD) is indeed part of an SMD before performing data transfer with the AP (MLD).

In certain embodiments, the client establishes trust with the SMD before performing a secure association with the SMD, and validates that an AP (MLD) claiming to be part of the SMD is indeed a part of the SMD.

In certain embodiments, the SMD identifier associated with the SMD may be used for cryptographic identification. Any one of the following may be used as a SMD identifier: (i) a SMD MAC address (distinct from a 802.11be MLD address or replacement thereof as indicated by an association), (ii) a globally unique 48 bit identifier, and (iii) a unique identifier assigned for each SMD, such as a NID.

Additionally, in certain embodiments, a SMD may be assigned an optional user friendly identifier referred to as a SMD MLD name (e.g., username) for display purposes to end users. The SMD MLD name can be advertised using the similar scheme for the unique SMD identifier described herein. By way of example, in certain embodiments, the SMD MLD IE may be included in the beacon and probe response frames and may include SMD information, such as the SMD identifier and SMD MLD name, as illustrative examples, along with SMD authentication check information for establishing trust for an SMD. Note the SMD authentication check information is described in greater detail herein.

In certain embodiments, the client can employ a trust on first use (TOFU) authentication technique to establish trust for a SMD. In TOFU authentication, when a client discovers a SMD (e.g., from a SMD MLD IE received in a beacon frame which is not in the list of trusted SMDs), the client can present the SMD information, such as the SMD MLD name, SMD identifier, corresponding public key, among other information, to the end user in order to verify that the user trusts the SMD. If the end user verifies that the end user trusts the SMD, then the client can store an indication that the SMD is trusted.

Additionally, in TOFU authentication, the client may further verify that the affiliated AP (e.g., AP 115) and the AP MLD (e.g., AP 120) is indeed part of that SMD. For this purpose, a public/private key pair can be generated for the SMD, e.g., by the controller (e.g., controller 130) or one of the AP MLDs. The public key corresponding to an SMD identifier (e.g., MDMI) can be shared with clients through various methods, such via broadcast to clients in beacons, as an illustrative example. Each AP transmitting the SMD identifier in the beacon may obtain the SMD information as well as AP MLD information (e.g. AP MLD MAC address, AP basic service set identifier (BSSID), etc.) signed by the entity holding the SMD private key. To avoid replay attacks, a nonce/Replay counter can be included in the SMD signature generation.

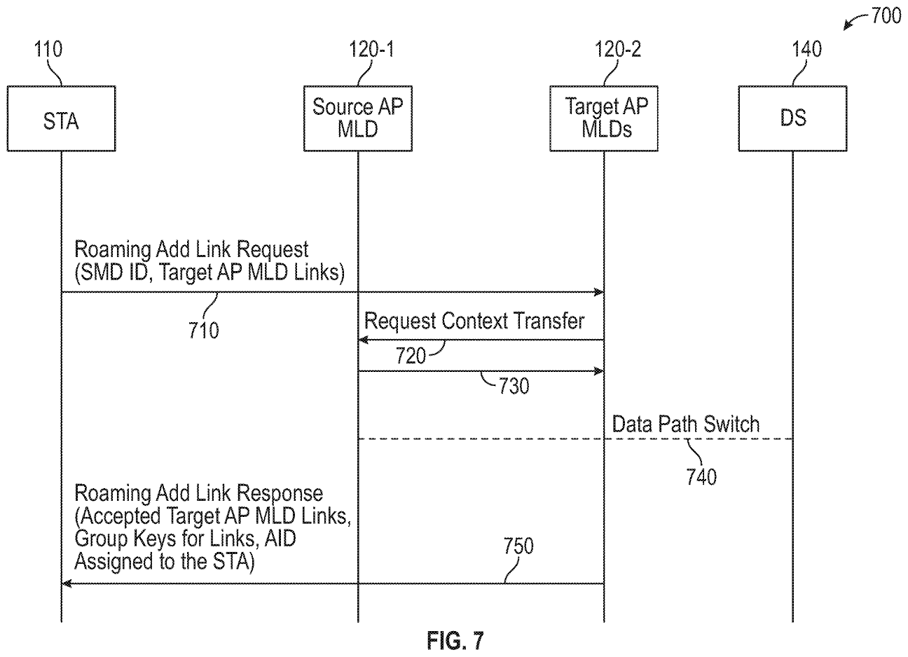

FIG. 8 illustrates an example workflow 800 for generating a SMD signature, according to certain embodiments. Note the workflow 800 may be used any of the techniques described herein for cryptographically establishing trust with an SMD, such as TOFU authentication, public key infrastructure (PKI) authentication, and certificate authority (CA) signed-certificate based authentication. Note, PKI authentication and CA signed-certificate based authentication are described in greater detail below.

As shown in FIG. 8, the SMD signature generation may involve an AP (MLD) generating a message 810 (e.g., beacon) that includes SMD information, AP information, a nonce/replay counter, operating channel information, or any combination thereof. The operating channel information may include, for example, an operating class and channel number for the beacon. In certain embodiments, the operating channel information may be included with the SMD information, AP information, and nonce/replay counter in order to avoid a replay attack on a different channel.

The SMD signature generation may further involve generating a hash of the message (e.g., message hash 830) using a hash algorithm 820. The hash algorithm 820 may be any suitable hash algorithm, such as any version of the secure hash algorithm (SHA) (e.g., SHA-256), as an illustrative example. The message hash 830 may be encrypted at an encryption block 840 using a private key 850 in order to generate the SMD signature 860.

In certain embodiments, the generated SMD signature can be sent in a beacon transmitted by an AP (MLD). In some examples, the SMD Signature (plus nonce/replay counter if used) can be sent as part of the SMD MLD IE in the beacon. In some cases, elliptic-curve cryptography (ECC) can be used to keep the size of the SMD signature smaller. For example, the elliptic curve digital signature algorithm (ECDSA) may result in 64 bytes signature, whereas the Rivest-Shamir-Adleman (RSA) encryption may result in 256 bytes signature. In addition to using ECC, the SMD signature can be hashed to a smaller size, such as 4 bytes, suitable for inclusion in the beacon.

Upon receiving a beacon with the SMD information and the SMD signature, the client may verify the SMD signature using the public key of that SMD over the beacon information used to generate the signature (e.g., SMD information as well as AP MLD information, such as AP MLD MAC address and AP BSSID)). If the verification succeeds, then the client has successfully verified that the affiliated AP (and AP MLD) is indeed part of the SMD the AP (MLD) is advertising.

Note, in certain embodiments, the TOFU authentication can also use a self-signed certificate for the root of the chain.

In certain embodiments, the client can employ a public/private key pair (public key infrastructure (PKI)) authentication technique to establish trust for a SMD. In such embodiments, the client(s) get provisioned with a public key of the SMD as part of the client provisioning process. For example, enterprise IT may provision a SMD public key along with MDMI on the enterprise devices. Such provisioning might include an allow-list for many known-good SMDs. Compared to the TOFU authentication technique, in this case, the public key may not be transmitted to the clients. However, similar to the TOFU authentication technique, an affiliated AP transmitting the MDMI in the beacon frame may include an SMD signature signed over the SMD information+AP MLD information (e.g. AP MLD MAC address+AP BSSID). The SMD signature may be generated by the entity holding the private key for SMD, which may or may not be the AP MLD. In the latter case, the AP MLD may have to communicate with the entity holding the public key to get the SMD signature.

In PKI authentication, a client can verify the received SMD signature based on the SMD public key provisioned for that MDMI on the client. If the signature verification succeeds, then the SMD is considered trusted, and the client has also verified that the affiliated AP (and AP MLD) is indeed part of the SMD that the affiliated AP (MLD) is advertising.

In certain embodiments, the client can employ a certificate authority (CA) signed-certificate based authentication technique to establish trust for a SMD. In such embodiments, the SMD may have a CA signed certificate issued to the SMD by a CA. An entity (e.g., controller 130, one of the AP MLDs 120) maintains the private key of the public/private key pair for the SMD. In one embodiment, the SMD certificate may include the MDMI plus SMD public key plus any additional information about the SMD. The CA issued SMD certificate can be installed on the client devices (e.g. by enterprise IT) as part of the client provisioning out of band.

Similar to the TOFU authentication technique and PKI authentication technique, an affiliated AP transmitting the MDMI in the beacon frame may get the entity holding the SMD private key to sign the SMD information plus AP MLD information (e.g. AP MLD MAC Address plus AP BSSID) and generate the SMD signature. The AP may include the SMD signature in the beacon frame as well.

In certain embodiments, a client device can verify the received SMD signature based on the SMD public key from the SMD certificate provisioned for that MDMI on the client. If the signature verification succeeds, then the SMD is considered trusted, and the client has also verified that the affiliated AP (and AP MLD) is indeed part of the SMD it is advertising.

In the CA signed-certificate based authentication technique, a second level certificate can be issued for each AP MLD by the SMD, signed by the private key of the SMD. In some examples, the AP MLD certificate includes the AP MLD public key and AP MLD MAC address, among other information. Then both the SMD certificate and AP MLD certificate gets installed at the clients, e.g., as part of client provisioning done out of band. Then the AP (MLD) can sign the SMD information plus AP MLD information locally using its own private key (e.g., AP MLD private key) to generate the SMD signature, instead of getting the entity holding the SMD private key to generate the signature. Using the AP (MLD)'s own private key to generate the SMD signature may be a more scalable approach as opposed to using the entity holding the SMD private key to generate the signature. A client device can verify the received SMD signature using the certificate chain provisioned on the device.

In all the three approaches discussed herein (e.g., TOFU authentication, PKI authentication, and CA signed-certificate based authentication), the replay attack for SMD Signature can be avoided by including a nonce or replay Counter in the signature generation. As a result, a new SMD signature may have to be generated for each transmitted beacon.

However, in some architectures, it may not be desired or feasible to generate a new SMD signature every beacon interval. For example, in such architectures, the SMD signature may not include a nonce/replay counter. Additionally, to reduce compute overhead in the network, since generating a PKI signature can be compute intensive, it be desirable to avoid every AP MLD in the SMD having to communicate with the entity holding the SMD private key every beacon interval, e.g. for backhaul scalability reasons (although this is less of a problem with a second level certificate).

Nevertheless, even if the nonce/replay counter plus operating channel information is included in the SMD signature, a MITM could still replay the beacon on the same channel number some amount of time later (e.g., an hour or so later) after RRM moved the genuine AP to a different channel or genuine AP has been disabled for some reason.

Thus, scenarios that involve avoiding generation of a new SMD signature every beacon interval and scenarios that involve including a nonce/replay counter plus operating channel information in the SMD signature may increase the risk of having a rogue AP (MLD) masquerading as a genuine AP (MLD) part of the SMD and acting as a MITM attacker, by replaying the SMD signature it can retrieve from the beacon frames of a genuine AP. In these deployments, to prevent such MITM attacks, a client can perform additional nonce exchanges with the AP, to verify that the AP (MLD) is indeed part of the SMD by verifying liveness of the SMD signature.

In certain embodiments, for this verification the client-AP exchange flow may involve the following steps:
(a) Client receives the SMD signature and either the public key or MDMI from the beacon. If the MDMI is present in the beacon, then the client uses the MDMI as an identifier for the corresponding public key.
(b) Client generates a CNonce and sends to the AP.
(c) AP generates an ANonce. The AP communicates the CNonce to the SMD key holder (holding the MDM private key) which signs the tuple {CNonce, ANonce, SMD Information (including MDMI), AP MLD Information (AP MLD MAC Address plus AP BSSID), operating class, channel number} and generates a new SMD signature.
(d) The AP sends the generated SMD signature (e.g., live SMD signature) directly to the client. The client verifies the received SMD signature using the SMD public key it knows. If the verification succeeds, the client trusts the SMD and has verified that the AP/AP MLD is indeed part of the SMD advertised.

In certain embodiments, the above protocol can be realized using fast transition (FT) association.

Since above steps involve additional 1:1 exchanges between the client and the AP, some clients by default may not support this additional verification, and may choose to only verify the received SMD signature from the beacon, without the additional 1:1 exchanges for verifying the SMD signature (e.g., steps (a)-(d)).

In such cases, the clients may use one of the following two approaches, Approach A and Approach B, to verify the received SMD signature from the beacon:

Approach A: If a nonce/replay counter is not used in the SMD signature generation, then the clients could verify the liveness of the SMD signature through additional 1:1 exchange as described in steps (a)-(d) described herein. The client would know if a nonce/replay counter is used since that field is sent in the beacon along with the SMD signature.

Approach B—Using AP-to-AP verification, a genuine AP in the ESS network can perform the steps described in (a)-(d) with other APs it can see over the air, to verify if the AP is indeed part of the advertised SMD. If verification does not succeed for one or more APs it is seeing, then the genuine AP can signal presence of such ‘Rogue APs’ to non-AP STAs. However, this measure may not be relied on if a non-AP STA can only see Rogue APs.

In certain embodiments, the SMD signature that is generated using the aforementioned techniques may be sent in a directed probe response to the client, instead of being sent in the beacon. Sending the SMD signature in a directed probe response may provide more efficient resource usage on the AP (e.g., avoiding regeneration of the signature every beacon interval) and can also address replay attack concerns by having the client send a client nonce (CNonce) in the probe request. The SMD signature may include the CNonce and AP nonce (ANonce), and may be sent back in the directed probe response to the client, along with the ANonce. The client (e.g., STA) verifies the SMD signature to pre-authenticate the SMD before associating with the SMD.

In certain embodiments, the SMD signature that is generated using the aforementioned techniques may be sent in an access network query protocol (ANQP) query response message. After discovering an SMD in the beacon, a STA can send an ANQP query request message with a CNonce to the AP. The AP generates an ANonce and includes both CNonce and ANonce in the generation of the SMD signature. The SMD signature is then sent to the STA (along with the ANonce) in the ANQP query response message. The STA verifies the SMD Signature to pre-authenticate the SMD before associating with the SMD.

Advantageously, the aforementioned techniques described herein (e.g., TOFU authentication, PKI authentication, and CA signed-certificate based authentication) enable clients to pre-authenticate a SMD before establishing secure association with the SMD. This ensures that clients do not connect with ‘Rogue APs’ masquerading as APs that are part of a mobility domain. This also avoids MITM attacks by rogue APs in the seamless roaming architecture where clients associate with a mobility domain MLD (e.g. campus wide ESS network), rather than performing separate association with each AP MLD in the mobility domain.

### Discovery, Authentication, and Association Within a Seamless Mobility Domain

As noted herein, to provide smooth roaming/mobility in a campus wide wireless network, clients can associate with an ESS instead of with an individual AP MLD. The ESS, for example, may be a global network with one or more campuses or a campus-wide network. As noted with respect to FIG. 2, in embodiments where the ESS is a global network with one or more campuses, each campus may correspond to (or be associated with) a respective SMD. On the other hand, in embodiments where the ESS maps to a single campus, the ESS may include a single SMD associated with campus.

The client creates its association with the ESS network represented by a SMD, instead of associating with a single AP (MLD) within the ESS. Such an architecture will enable a client to roam seamlessly between AP MLDs without requiring (re)association and reestablishment of contexts with each new AP MLD, since the client associates with the SMD covering all the AP MLDs of the ESS. Such an architecture can significantly reduce roaming time to realize seamless roaming.

Certain embodiments described herein provide improved techniques for discovery, authentication, and association procedures to support association to a SMD. As described herein, an SMD may refer to a logical entity covering multiple AP MLDs, e.g., all AP MLDs which are part of an ESS.

As noted, a SMD may be identified by a unique identifier referred to as MDMI or SMD MAC address. In some cases, the unique identifier for the SMD can be used by the system wide NID (paired with an SSID) as a local network identifier. The NID to SMD mapping can be changed upon association to a new SMD. A non-AP MLD can associate with the SMD identified via its unique identifier.

Certain embodiments described herein provide the following enhancements to support association to a SMD.

### 1) Advertisement and Discovery of a SMD

A SMD MLD IE is defined and is carried in the beacon and/or probe response frames by the APs of the AP MLDs which are part of the SMD, to advertise the SMD information. The SMD MLD IE can include: MDMI (aka SMD MAC address)-a unique identifier for the SMD covering multiple AP MLDs, a user friendly SMD MLD name (if not already identified in the NID bundle), SMD roaming capabilities, or any combination thereof. In one embodiment, the SMD MLD Name may be treated as a (possibly null) suffix or modifier to the SSID: e.g., “blizzard” becomes “blizzard at San Jose”.

If not already identified in the NID bundle, SMD roaming capabilities indicate support for MLD level roaming, support for link level roaming, support for roaming quality levels (RQLs)/make before break routing (MBBR) modes, and/or SMD pre-association authentication information. The SMD pre-association authentication information may be optional based on the security requirements of the SMD and may be used by the clients associating with the SMD to pre-authenticate the SMD before association.

A non-AP MLD discovers the SMD from the SMD MLD IE that is received from beacon or probe responses from an AP MLD(s). A non-AP MLD discovers the AP MLDs which are part of the SMD.

### 2) Authentication and Association to a SMD

A non-AP MLD determines which SMD to associate with based on the set of SMDs it discovers, capabilities of those SMDs and its own set of capabilities. For example, a non-AP MLD may decide to only associate with an SMD if it provides information to pre-authenticate the SMD before association.

Once a non-AP MLD has selected the SMD to associate with, it then selects through which of the discovered AP MLDs of that SMD it wants to use to authenticate and associate with the SMD. The non-AP MLD then initiates authentication by sending an authentication request frame, which includes the SMD MLD IE or SMD MAC address to indicate that the authentication is happening with the SMD, and not just with the AP MLD. The non-AP MLD successfully authenticates with the SMD as per the selected authentication algorithm. The non-AP MLD then performs the mobility domain association with the SMD by sending, to the selected AP MLD, an association request frame that includes the SMD MLD IE, along with the Basic ML element indicating which links of the AP MLD it wants to establish as part of its ML setup with the SMD. The association request frame indicates that the non-AP MLD is associating with the SMD, and not just with the AP MLD.

### 3) Unicast Key/PTK Generation for Mobility Domain MLD or SMD

After a non-AP MLD completes its association with the SMD by establishing ML setup with an AP MLD which is part of the SMD, in certain embodiments, a 4-way handshake is executed to establish the unicast key/PTK. The PTK generation gets tied with the unique MDMI or SMD MAC address to link the PTK with the SMD. The AP MLD and the non-AP MLD use the MDMI or SMD MAC address as input to the PTK generation.

Once the PTK is generated as part of the 4-way handshake after association with a SMD, the same PTK can be used for all the setup links of that non-AP MLD, when it roams to other AP MLDs which are part of the same SMD. After client's initial association with the SMD through an AP MLD, the security context (PMKSA, PTK, etc.) may be distributed using the backend infrastructure and PTK key gets installed on all AP MLDs of the SMD.

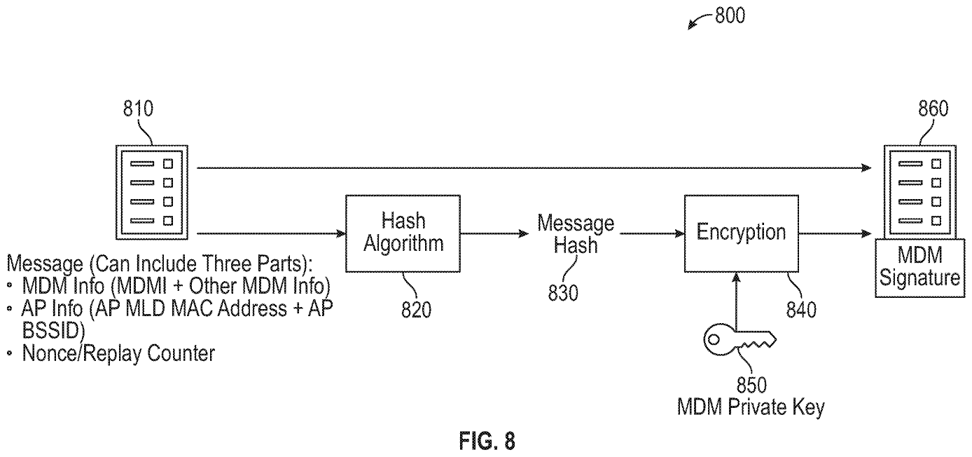

FIG. 9 is an example call flow 900 for an add link operation via a target AP MLD during seamless roaming, according to certain embodiments. As shown, as part of the initial SMD association, at 902, the STA MLD 110 (or non-AP MLD) and source AP MLD 120-1 (or serving AP MLD) participate in an authentication procedure. For example, the authentication procedure may involve the STA MLD 110 sending an authentication request message to the source AP MLD 120-1, and the source AP MLD 120-1 sending an authentication response message to the STA MLD 110 in response to the authentication request message.

In certain embodiments, the authentication request message and the authentication response message may include a multilink element (MLE) and an SMD element (SMDE). The SMDE may be added to the authentication frames (e.g., authentication request message and authentication response message) to indicate that authentication is being performed with the SMD 170, as opposed to solely with the source AP MLD 120-1. For example, the SMDE may include information about the SMD, such as SMD 170. In certain embodiments, the SMDE may include the SMD MAC address, an indication of SMD capabilities and operations, among other information. The SMD capabilities and operations may include, without limitation, an indication of (i) the roaming mode that is supported (e.g., distributed SMD or centralized SMD), (ii) whether resource reservation on target AP is supported, (iii) whether data transfer between APs is supported, (iii) whether context transfer is supported, (iv) whether context negotiation is supported, or (v) any combination thereof. In distributed SMD, each AP MLD of the SMD may have a MAC service access point (SAP) to the DS. In centralized SMD, the SMD MLD has one MAC SAP to the DS.

In certain embodiments, the SMDE may also be included in association frames, such as association request and association response messages. At 904, for example, the STA MLD 110 transmits a (re)association request message, which includes the MLE and the SMDE, to the source AP MLD 120-1. At 906, the source AP MLD 120-1 transmits a (re)association response message, which includes the MLE and the SMDE, to the STA MLD 110. The SMDE may be included within the association frames to signal that the association is being performed with the SMD, as opposed to solely with the source AP MLD 120-1.

At 908, the PMK for the SMD (e.g., PMK_{SMD}) is generated based on an 802.1x/EAP authentication. At 910, a 4-way handshake procedure is performed to establish a PTK for the SMD (e.g., PTK_{SMD}). The 4-way handshake procedure may involve (i) a first message (M1) transmitted from the source AP MLD 120-1 to the STA MLD 110, (ii) a second message (M2) transmitted from the STA MLD 110 to the source AP 120-1, (iii) a third message (M3) transmitted from the source AP 120-1 to the STA MLD 110, and (iv) a fourth message (M4) transmitted from the STA MLD 110 to the source AP 120-1.

In certain embodiments, the 4-way handshake messages (e.g., M1-M4) may be enhanced (or modified) to include the SMDE (or any portion thereof). For example, in certain embodiments, the 4-way handshake messages may include an indication of the SMD MAC address (as opposed to other information within the SMDE). In other embodiments, the 4-way handshake messages may include the SMDE. Here, at 908, the first message (M1) includes, without limitation, ANonce, PMKID, and SMD MAC address (or SMDE). The second message (M2) includes, without limitation, supplicant nonce (SNonce), message integrity code (MIC), SMD MAC address (or SMDE), and PMKID. The third message (M3) includes, without limitation, ANonce, MIC, SMD MAC address (or SMDE), PMKID, among other information (e.g., GTK/IGTK/BIGTK KDEs, etc.). The fourth message (M4) includes, without limitation, MIC and SMD MAC address (or SMDE).

At 912, the STA MLD 110 and source AP MLD 120-1 may exchange data (e.g., uplink/downlink data). Note, in certain embodiments, PMK_{SMD} and PTK_{SMD} generation may be based on (or otherwise associated with) the SMD MAC address.

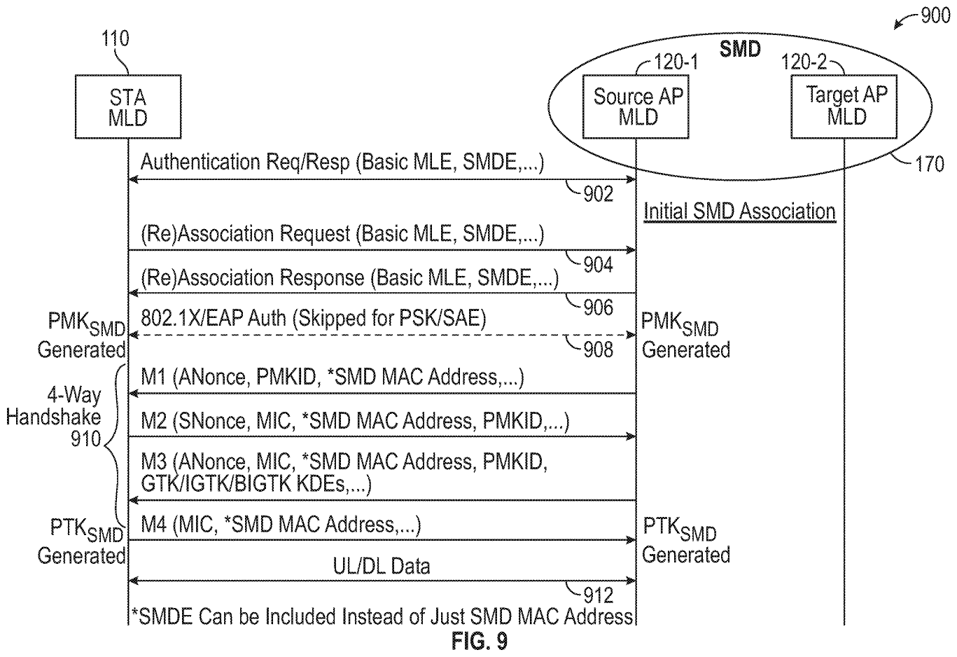

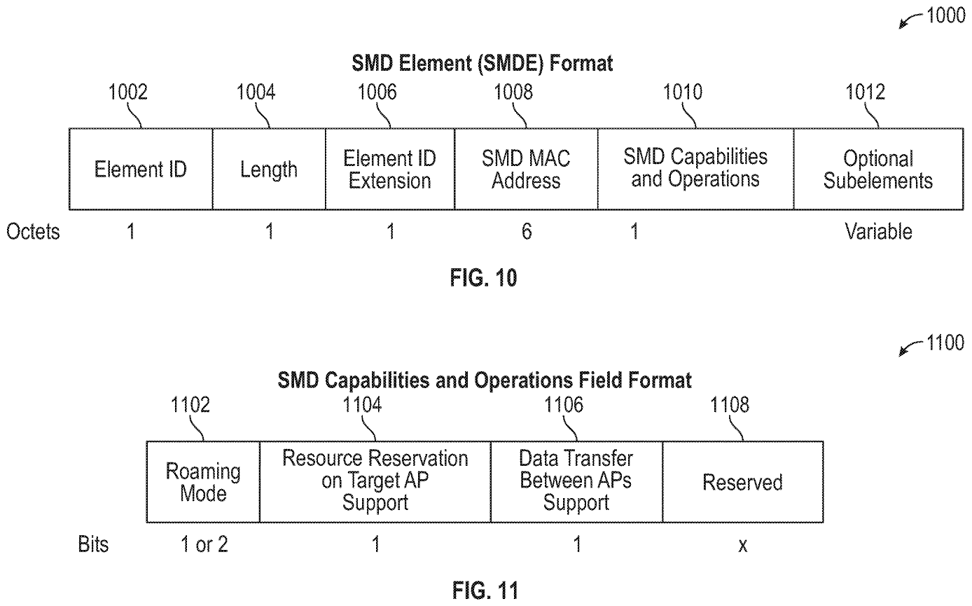

FIG. 10 depicts an example SMDE frame format 1000, according to certain embodiments. The SMDE frame format 1000 may be used for the SMDE included in one or more of the messages described above with respect to FIG. 9. For example, in general, the SMDE (using SMDE frame format 1000) may be included in beacon, probe response, and/or other management frames to allow clients to discover a SMD. As shown, the SMDE frame format 1000 includes, without limitation, an element ID field 1002, a length field 1004, an element ID extension field 1006, a SMD MAC address field 1008, a SMD capabilities and operations field 1010, and an optional subelements field 1012. The SMD MAC address field 1008 includes an indication of the SMD MAC address. The SMD capabilities and operations field 1010 is described in greater detail below with respect to FIG. 11. The optional subelements field 1012 may include one or more subelements to provide further information regarding the SMD.

FIG. 11 depicts an example SMD capabilities and operations field format 1100. The format 1100 may be used for the SMD capabilities and operations field 1010 of the SMDE frame format 1000. As shown, the format 1100 includes, without limitation, a roaming mode field 1102, a resource reservation on target AP support field 1104, a data transfer between APs support field 1106, and a reserved field 1108.

The roaming mode field 1102 includes an indication of the roaming mode supported. For example, the roaming mode may indicate distributed SMD or centralized SMD. As noted, in distributed SMD, each AP MLD of the SMD may have a MAC service access point (SAP) to the DS. In centralized SMD, the SMD MLD has one MAC SAP to the DS. The resource reservation on target AP support field 1104 includes an indication of whether resource reservation on target AP is supported. The data transfer between APs support field 1106 includes an indication of whether data transfer between APs is supported.

Advantageously, the aforementioned embodiments define enhancements to discovery, authentication and association procedures to support association to a SMD in a wireless network (e.g., IEEE 802.11 wireless network, such as IEEE 802.11bn (or WiFi 8) covering multiple non-collocated AP MLDs of the ESS, to enable seamless roaming across AP MLDs within the ESS.

### EXAMPLE OPERATIONS

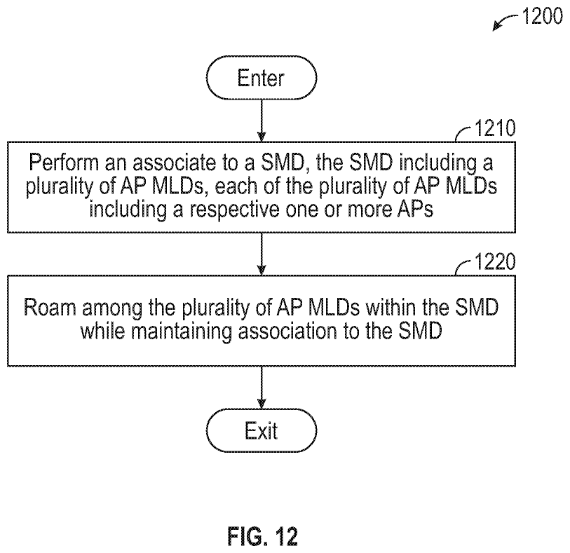

FIG. 12 is a flowchart of a method 1200 for facilitating seamless roaming within a SMD (e.g., SMD 170). The method 1200 may be performed by a wireless device, such as a client (e.g., STA MLD 110).

Method 1200 enters at block 1210, where the client performs an association to an SMD (e.g., SMD 170). The SMD includes a plurality of AP MLDs (e.g., AP MLDs 120). Each of the AP MLDs includes a respective one or more APs (e.g., APs 115).

At block 1220, the client roams among the AP MLDs within the SMD while maintaining association to the SMD.

In certain embodiments, performing the association to the SMD may include associating to the SMD through a first AP MLD (e.g., AP MLD 120-1) of the plurality of AP MLDs within the SMD. In such embodiments, associating through the first AP MLD may include transmitting, to the first AP MLD, a first message (e.g., (re)association request message) including information associated with the SMD. The information associated with the SMD may include at least one of (i) an identifier associated with the SMD (e.g., SMD MAC address), (ii) a username associated with the SMD (e.g., SMD MLD name), (iii) authentication information (e.g., SMD authentication check information or SMD pre-association authentication information), (iv) capabilities indication for the SMD, or (v) supported roaming modes. The first message may indicate to the first AP MLD that the wireless device is performing the association to the SMD.

In certain embodiments, the method 1200 may further involve obtaining the information associated with the SMD from at least one of a beacon, probe response message, or another management message received from the first AP MLD.

In certain embodiments, the first message (e.g., (re)association request message) may further include an indication of one or more links of the first AP MLD that the wireless devices wants to establish as part of the association with the SMD. In such embodiments, associating to the SMD through the first AP MLD may further include establishing the one or more links with the first AP MLD.

In certain embodiments, the association to the SMD through the first AP MLD establishes a security context for the wireless device that applies to each of the plurality of AP MLDs within the SMD. The security context may include a PMKSA (including a PMK) and a PTKSA (including a PTK).

In certain embodiments, performing the association to the SMD may further include refraining from associating to the SMD through a second AP MLD of the plurality of AP MLDs within the SMD.

In certain embodiments, roaming among the plurality of AP MLDs may include establishing one or more links with a second AP MLD (e.g., AP MLD 120-2) of the plurality of AP MLDs within the SMD while maintaining one or more links with the first AP MLD (e.g., AP MLD 120-1). In such embodiments, roaming among the plurality of AP MLDs may include transferring a context corresponding to the wireless device from the first AP MLD to the second AP MLD. Additionally or alternatively, in such embodiments, roaming among the plurality of AP MLDs may include switching a data path for the wireless device from the first AP MLD to the second AP MLD.

In some embodiments, establishing the one or more links with the second AP MLD may include: (i) transmitting, to the second AP MLD, a second message comprising the information associated with the SMD; and (ii) receiving, from the second AP MLD, a third message including the information associated with the SMD and an AID allocated to the wireless device by the second AP MLD.

In some embodiments, establishing the one or more links with the second AP MLD may include: (i) transmitting, to the first AP MLD, a second message comprising the information associated with the SMD; and (ii) receiving, from the first AP MLD, a third message comprising the information associated with the SMD and an association ID allocated to the wireless device by the second AP MLD.

In certain embodiments, the method 1200 may further involve performing an authentication with the SMD prior to performing the association to the SMD. In such embodiments, performing the authentication with the SMD may include authenticating with the SMD through the first AP MLD. Authenticating with the SMD through the first AP MLD may include transmitting, to the first AP MLD, a second message (e.g., authentication request message) including the information associated with the SMD. The second message may indicate to the first AP MLD that the wireless device is performing the authentication with the SMD.

In certain embodiments, performing the authentication with the SMD may further include refraining from authenticating with the SMD through a second AP MLD of the plurality of AP MLDs within the SMD.

In certain embodiments, the authentication request message and/or the (re)association request message may include an SMDE, which includes information associated with the SMD.

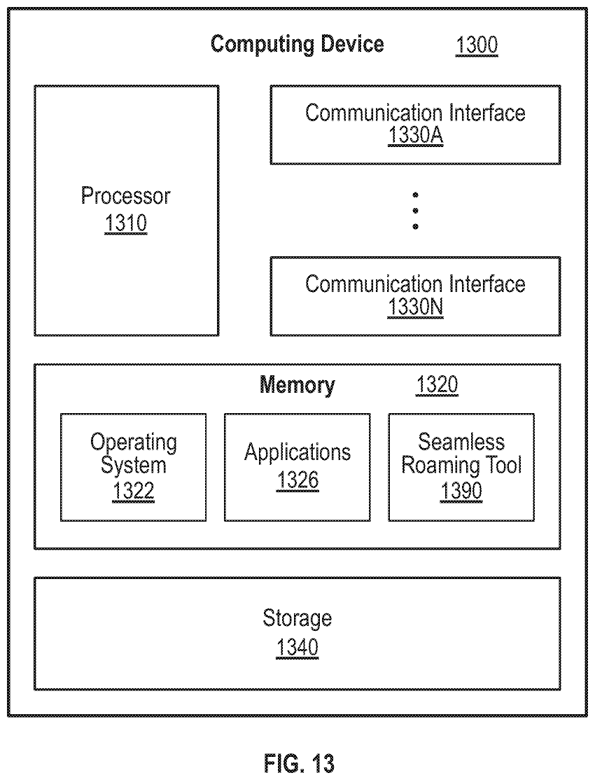

FIG. 13 illustrates an example computing device 1300, according to one embodiment. The computing device 1300 can be configured to perform one or more techniques described herein for facilitating seamless roaming within a SMD. For example, the computing device 1300 can perform method 1200 and any other techniques (or combination of techniques) described herein. The computing device 1300 may be representative of a controller (e.g., controller 130), a network entity (e.g., an AP MLD, such as AP MLD 120), or a wireless device (e.g., STA MLD 110). The computing device 1300 includes, without limitation, a processor 1310, a memory 1320, and one or more communication interfaces 1330a-n (generally, communication interface 1330). In one example, the communication interface 1330 includes a radio.

The processor 1310 may be any processing element capable of performing the functions described herein. The processor 1310 represents a single processor, multiple processors, a processor with multiple cores, and combinations thereof. The communication interfaces 1330 (e.g., radios) facilitate communications between the computing device 1300 and other devices. The communications interfaces 1330 are representative of wireless communications antennas and various wired communication ports.

The memory 1320 may be either volatile or non-volatile memory and may include RAM, flash, cache, disk drives, and other computer readable memory storage devices. Although shown as a single entity, the memory 1320 may be divided into different memory storage elements such as RAM and one or more hard disk drives. As shown, the memory 1320 includes various instructions that are executable by the processor 1310 to provide an operating system 1322 to manage various functions of the computing device 1300. The memory 1320 also includes seamless roaming tool 1390 and one or more application(s) 1326.

The computing device 1300 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

### EXAMPLE CLAUSES

Implementation examples are described in the following numbered clauses:

Clause 1: A computer-implemented method for wireless communications performed by a wireless device, the computer-implemented method comprising: performing an association to a seamless mobility domain (SMD), the SMD comprising a plurality of access point (AP) multi-link devices (MLDs), each of the plurality of AP MLDs comprising a respective one or more APs; and roaming among the plurality of AP MLDs within the SMD while maintaining association to the SMD.

Clause 2: The computer-implemented method of Clause 1, wherein: performing the association to the SMD comprises associating through a first AP MLD of the plurality of AP MLDs within the SMD; and associating through the first AP MLD comprises transmitting, to the first AP MLD, a first message comprising information associated with the SMD.

Clause 3: The computer-implemented method of Clause 2, wherein the first message indicates to the first AP MLD that the wireless device is performing the association to the SMD.

Clause 4: The computer-implemented method in accordance with any of Clauses 2-3, wherein the information associated with the SMD comprises at least one of (i) an identifier associated with the SMD, (ii) a username associated with the SMD, (iii) authentication information, (iv) capabilities indication for the SMD or (v) supported roaming modes.

Clause 5: The computer-implemented method of Clause 4, wherein the identifier associated with the SMD comprises a SMD medium access control (MAC) address.

Clause 6: The computer-implemented method in accordance with any of Clauses 2-5, further comprising obtaining the information associated with the SMD from at least one of a beacon or probe response or another management message received from the first AP MLD.

Clause 7: The computer-implemented method in accordance with any of Clauses 2-6, wherein: the first message further comprises an indication of one or more links of the first AP MLD that the wireless device wants to establish as part of the association with the SMD; and associating through the first AP MLD further comprises establishing the one or more links with the first AP MLD.

Clause 8: The computer-implemented method in accordance with any of Clauses 2-7, wherein the association through the first AP MLD establishes a security context for the wireless device that applies to each of the plurality of AP MLDs within the SMD.

Clause 9: The computer-implemented method of Clause 8, wherein the security context comprises (i) a pairwise master key security association (PMKSA) that includes a pairwise master key (PMK) and (ii) a pairwise transient key security association (PTKSA) that includes a pairwise transient key (PTK).

Clause 10: The computer-implemented method in accordance with any of Clauses 2-9, wherein performing the association to the SMD further comprises refraining from associating through a second AP MLD of the plurality of AP MLDs within the SMD.

Clause 11: The computer-implemented method in accordance with any of Clauses 2-10, wherein roaming among the plurality of AP MLDs comprises establishing one or more links with a second AP MLD of the plurality of AP MLDs within the SMD while maintaining one or more links with the first AP MLD.

Clause 12: The computer-implemented method of Clause 11, wherein roaming among the plurality of AP MLDs comprises at least one of (i) transferring a context corresponding to the wireless device from the first AP MLD to the second AP MLD or (ii) switching a data path for the wireless device from the first AP MLD to the second AP MLD.

Clause 13: The computer-implemented method in accordance with any of Clauses 11-12, wherein establishing the one or more links with the second AP MLD comprises: transmitting, to the second AP MLD, a second message comprising the information associated with the SMD; and receiving, from the second AP MLD, a third message comprising the information associated with the SMD and an association ID allocated to the wireless device by the second AP MLD.

Clause 14: The computer-implemented method in accordance with any of Clauses 11-13, wherein establishing the one or more links with the second AP MLD comprises: transmitting, to the first AP MLD, a second message comprising the information associated with the SMD; and receiving, from the first AP MLD, a third message comprising the information associated with the SMD and an association ID allocated to the wireless device by the second AP MLD.

Clause 15: The computer-implemented method in accordance with any of Clauses 2-14, further comprising performing an authentication with the SMD prior to performing the association to the SMD.

Clause 16: The computer-implemented method of Clause 15, wherein: performing the authentication with the SMD comprises authenticating through the first AP MLD; and authenticating through the first AP MLD comprises transmitting, to the first AP MLD, a second message comprising the information associated with the SMD.

Clause 17: The computer-implemented method of Clause 16, wherein the second message indicates to the first AP MLD that the wireless device is performing the authentication with the SMD.

Clause 18: The computer-implemented method according to any of Clauses 15-17, wherein performing the authentication with the SMD comprises refraining from authenticating through a second AP MLD of the plurality of AP MLDs within the SMD.

Clause 19: The computer-implemented method in accordance with any of Clauses 16-18, wherein: the first message comprises an association request message or a reassociation request message comprising an SMD element (SMDE) comprising the information associated with the SMD; and the second message comprises an authentication request message comprising the SMDE comprising the information associated with the SMD.

Clause 20: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-19.

Clause 21: A non-transitory computer-readable medium comprising computer-executable code, which when executed by one or more processors of a computing device perform a method in accordance with any of Clauses 1-19.

Clause 22: An apparatus comprising means for performing a method in accordance with any of Clauses 1-19.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
establishing, by a first access point (AP) multilink device (MLD) of a seamless mobility domain (SMD), an association between the SMD and a non-AP MLD,
wherein the SMD comprises the first AP MLD and a second AP MLD;
wherein the first AP MLD and the second AP MLD each comprises two or more affiliated APs and the non-AP MLD comprises two or more stations (STAs); and
wherein the association comprises at least one link between a first affiliated AP of the first AP MLD and a first STA of the non-AP MLD;
wherein establishing the association comprises receiving, from the non-AP MLD, an association request, the association request including data identifying the SMD;
transmitting an association response to the non-AP MLD, the association response including data identifying the SMD;
receiving, by the first AP MLD, a request frame from the non-AP MLD, the request frame indicating one or more links associated with corresponding affiliated APs of the second AP MLD to add to the association between the SMD and the non-AP MLD;
forwarding, by the first AP MLD, data indicating the one or more links to the second AP MLD;
receiving, by the first AP MLD, a response from the second AP MLD indicating acceptance of at least one of the one or more links; and
transmitting, by the first AP MLD, a response frame to the non-AP MLD, the response frame including data indicating the acceptance of at least one of the one more links.

2. The method of claim 1, further comprising transferring, by the first AP MLD to the second AP MLD, data indicating context of the association with the non-AP MLD.

3. The method of claim 2, wherein the context of the association comprises one or more of packet number data, sequence number data, block acknowledge agreement data, target wake time agreement data, or stream classification service setup data.

4. The method of claim 2, wherein establishing the association further comprises exchanging messages between the first AP MLD and the non-AP MLD to establish a security context between the SMD and the non-AP MLD; and wherein the data indicating the context of the association includes one or more attributes of the security context.

5. The method of claim 4, wherein the security context comprises one or more of a pairwise master key or a pairwise transient key.

6. The method of claim 1, further comprising transmitting, by the first AP MLD, one or more management frames advertising the SMD, the one or more management frames including an SMD identifier associated with the SMD.

7. The method of claim 6, wherein the one or more management frames each comprise an SMD element that contains the SMD identifier.

8. The method of claim 6, wherein the one or more management frames are beacon frames.

9. The method of claim 1, further comprising removing the at least one link between the first affiliated AP of the first AP MLD and the first STA of the non-AP MLD from the association between the SMD and the non-AP MLD after completion of a roam event by the non-AP MLD to the second AP MLD.

10. An access point (AP) multi-link device (MLD) of a seamless mobility domain (SMD), comprising:
a processor;
two or more affiliated APs, each affiliated AP operative to establish a corresponding link with an affiliated station of a non-AP MLD, and
a memory communicatively coupled to the processor, wherein the memory comprises a Multi-Link Operation (MLO) management logic configured to perform operations comprising:
establishing, by the AP MLD, an association between the SMD and a non-AP MLD,
wherein the SMD comprises the AP MLD and a second AP MLD;
wherein the second AP MLD comprises two or more affiliated APs; and
wherein the association comprises at least one link between a first affiliated AP of the AP MLD and a first STA of the non-AP MLD;
wherein establishing the association comprises
receiving, from the non-AP MLD, an association request, the association request including data identifying the SMD;
transmitting an association response to the non-AP MLD, the association response including data identifying the SMD;
receiving, by the AP MLD, a request frame from the non-AP MLD, the request frame indicating one or more links associated with corresponding affiliated APs of the second AP MLD to add to the association between the SMD and the non-AP MLD;
forwarding, by the AP MLD, data indicating the one or more links to the second AP MLD;
receiving, by the AP MLD, a response from the second AP MLD indicating acceptance of at least one of the one or more links; and
transmitting, by the AP MLD, a response frame to the non-AP MLD, the response frame including data indicating the acceptance of at least one of the one more links.

11. The AP MLD of claim 10, the operations further comprising transferring, by the AP MLD to the second AP MLD, data indicating context of the association with the non-AP MLD.

12. The AP MLD of claim 11, wherein the context of the association comprises one or more of packet number data, sequence number data, block acknowledge agreement data, target wake time agreement data, or stream classification service setup data.

13. The AP MLD of claim 11, wherein establishing the association further comprises exchanging messages between the AP MLD and the non-AP MLD to establish a security context between the SMD and the non-AP MLD; and wherein the data indicating the context of the association includes one or more attributes of the security context.

14. The AP MLD of claim 13, wherein the security context comprises one or more of a pairwise master key or a pairwise transient key.

15. The AP MLD of claim 10, the operations further comprising transmitting, by the AP MLD, one or more management frames advertising the SMD, the one or more management frames including an SMD identifier associated with the SMD.

16. The AP MLD of claim 15, wherein the one or more management frames each comprise an SMD element that contains the SMD identifier.

17. The AP MLD of claim 15, wherein the one or more management frames are beacon frames.

18. The AP MLD of claim 10, the operations further comprising removing the at least one link between the first affiliated AP of the AP MLD and the first STA of the non-AP MLD from the association between the SMD and the non-AP MLD after completion of a roam event by the non-AP MLD to the second AP MLD.

19. A non-transitory computer readable storage medium comprising instructions that when executed configure one or more processors of an access point (AP) multi-link device (MLD) to perform operations comprising:
establishing, by the AP MLD of a seamless mobility domain (SMD), an association between the SMD and a non-AP MLD,
wherein the SMD comprises the AP MLD and a second AP MLD;
wherein the AP MLD and the second AP MLD each comprises two or more affiliated APs and the non-AP MLD comprises two or more stations (STAs); and
wherein the association comprises at least one link between a first affiliated AP of the AP MLD and a first STA of the non-AP MLD;
wherein establishing the association comprises
receiving, from the non-AP MLD, an association request, the association request including data identifying the SMD;
transmitting an association response to the non-AP MLD, the association response including data identifying the SMD;
receiving, by the AP MLD, a request frame from the non-AP MLD, the request frame indicating one or more links associated with corresponding affiliated APs of the second AP MLD to add to the association between the SMD and the non-AP MLD;
forwarding, by the AP MLD, data indicating the one or more links to the second AP MLD;
receiving, by the AP MLD, a response from the second AP MLD indicating acceptance of at least one of the one or more links; and
transmitting, by the AP MLD, a response frame to the non-AP MLD, the response frame including data indicating the acceptance of at least one of the one more links.

20. The non-transitory computer readable storage medium of claim 19, the operations further comprising transferring, by the AP MLD to the second AP MLD, data indicating context of the association with the non-AP MLD.

21. The non-transitory computer readable storage medium of claim 20, wherein the context of the association comprises one or more of packet number data, sequence number data, block acknowledge agreement data, target wake time agreement data, or stream classification service setup data.

22. The non-transitory computer readable storage medium of claim 20, wherein establishing the association further comprises exchanging messages between the AP MLD and the non-AP MLD to establish a security context between the SMD and the non-AP MLD; and wherein the data indicating the context of the association includes one or more attributes of the security context.

23. The non-transitory computer readable storage medium of claim 22, wherein the security context comprises one or more of a pairwise master key or a pairwise transient key.

24. The non-transitory computer readable storage medium of claim 19, the operations further comprising transmitting, by the AP MLD, one or more management frames advertising the SMD, the one or more management frames including an SMD identifier associated with the SMD.

25. The non-transitory computer readable storage medium of claim 24, wherein the one or more management frames each comprise an SMD element that contains the SMD identifier.

26. The non-transitory computer readable storage medium of claim 24, wherein the one or more management frames are beacon frames.

27. The non-transitory computer readable storage medium of claim 19, the operations further comprising removing the at least one link between the first affiliated AP of the AP MLD and the first STA of the non-AP MLD from the association between the SMD and the non-AP MLD after completion of a roam event by the non-AP MLD to the second AP MLD.
